(19) United States
(12) Patent Application Publication
(10) Pub. No.: US 2023/0200589 A1
(43) Pub. Date: Jun. 29, 2023

(54) Method and Apparatus for Scraping and Tamping

(71) Applicant: Midea Group Co., Ltd., Beijiao (CN)

(72) Inventors: Paul R. Staun, Sharonville, OH (US); Clayton James O'Donoghue, Shelbyville, KY (US); Bryce Bornhorn, Hebron, KY (US)

(21) Appl. No.: 17/560,645

(22) Filed: Dec. 23, 2021

(51) Int. Cl. A47J 43/07

(52) U.S. Cl. CPC A47J 43/0722; A47J 43/0711; A47J 2043/0738

(57) ABSTRACT

A scraping and tamping device for an appliance. The scraping and tamping device may tamp and/or scrap contents within the appliance. The scraping and tamping device may include a tamper and/or scraper. The scraping and tamping device may include a releasable engagement between one or more portions thereof. A retention device may be used to releasably engage the scraper between a stowed position and a deployed position. The scraping and tamping device may include a blender.

### BACKGROUND

The present embodiments relate to a device for scraping and tamping, more specifically for an appliance.

Typically spoons and/or spatulas are inserted into the container of a blender to scrap the interior surfaces of the container when no longer blending. However, stopping the blender to scrap the interior surfaces with the spatula/spoon may increase the application duration to process the contents therein and/or result in unwanted contact with the mixing assembly. Thus, there is a need to decrease the processing duration and/or increasing the efficiency of scraping and/or tamping the content(s) manually into the mixing assembly within the blender container before/during/after blending.

### SUMMARY

In some embodiments of the invention, for example, a scraping and tamping device may include a tamper having a proximal end and a distal end. In various embodiments, the device may include a scraper having a body, wherein the body includes at least one wiping blade. In some embodiments, the tamper may be positionable between a first configuration and a second configuration with the body of the scraper. In various embodiments, when in the first configuration the distal end of the tamper may engage the body of the scraper whereby the user manipulates the combined scraper and tamper. In some embodiments, when in the second configuration the distal end of the tamper may be disengaged from the body of the scraper whereby the user manipulates the tamper separate from the scraper.

In some embodiments, the device may be combined with a blender, wherein the blender may include a container removably attached to a base, wherein the container may include a mixing assembly engageable to a drive mechanism of the base, wherein the container may include a lid defining an opening, wherein the lid may be removably attached to the container, and wherein the tamper may extend through the opening of the lid and the scraper is positioned within the container. In various embodiments, the tamper may be in a first orientation when in the first configuration and a second orientation in the second configuration, wherein the first orientation may be different from the second orientation. In some embodiments, the device may include a releasable engagement between the tamper and the scraper. In various embodiments, the tamper may include a longitudinal axis extending between the proximal end and the distal end, and wherein the tamper may rotate about the longitudinal axis between the first configuration and the second configuration. In some embodiments, the device may include a sliding engagement between the tamper and the scraper when in the second configuration. In various embodiments, the sliding engagement may include the tamper sliding relative to the scraper in a stowed position.

In various embodiments, a blender may include a base having a drive mechanism. In some embodiments, the blender may include a container removably attached to the base, wherein the container may include a mixing assembly engageable to the drive mechanism of the base, and wherein the container may include a lid defining an opening, wherein the lid may be removably attached to the container. In various embodiments, the blender may include a scraper having a body, wherein the body may include at least one wiping blade. In some embodiments, the blender may include a tamper extending through the opening of the lid may be positionable between a first configuration and a second configuration with the body of the scraper, wherein when in the first configuration the tamper may engage the body of the scraper whereby the user manipulates the combined scraper and tamper within the container, and when in the second configuration the tamper may be disengaged from the body of the scraper whereby the user manipulates the tamper separate from the scraper within the container.

In addition, in some embodiments, the scraper may be positionable between a stowed position with the lid and a deployed position different from the stowed position. In various embodiments, the tamper may be positioned between the second configuration and the first configuration when the scraper is in the stowed position with the lid. In some embodiments, the blender may include a retention device to releasably engage the scraper relative to the lid between the stowed position and the deployed position. In various embodiments, the blender may include a sliding engagement between the tamper and the scraper when in the second configuration, wherein the tamper may slide relative to the scraper when in the stowed position. In some embodiments, the tamper may be in a first orientation when in the first configuration and a second orientation in the second configuration, wherein the first orientation may be different from the second orientation. In some embodiments, the blender may include a releasable engagement between the tamper and the scraper. In various embodiments, the tamper may include a proximal end and a distal end, and a longitudinal axis extending between the proximal end and the distal end, wherein the tamper may rotate about the longitudinal axis between the first configuration and the second configuration relative to the scraper.

In various embodiments, a method of scraping and/or tamping the contents of a blender container may include providing a blender having a base and a container removably attached to the base, wherein the base may include a drive mechanism, wherein the container may include a mixing assembly engageable to the drive mechanism of the base, wherein the container may include a lid defining an opening, and wherein the lid may be removably attached to the container. In some embodiments, the method may include providing a tamper having a proximal end and a distal end. In various embodiments, the method may include inserting the tamper through the opening of the lid into an interior of the container. In some embodiments, the method may include providing a scraper postionable with the container between a stowed position and a deployed position. In various embodiments, the method may include scraping the contents within the interior of the container with the tamper and the scraper when the scraper is in the deployed position. In some embodiments, the method may include tamping the contents within the interior of the container with the tamper when the scraper is in the stowed position.

In addition, in some embodiments, the method may include tamping the contents within the interior of the container with the tamper and the scraper when the scraper is in the deployed position. In various embodiments, the method may include both engaging and disengaging the tamper with the scraper when in the stowed position. In some embodiments, the method may include changing an orientation of the tamper relative to the scraper when both engaging and disengaging the tamper with the scraper when in the stowed position. In some embodiments, the method may include deploying the scraper from the lid. In various embodiments, the method may include stowing the scraper with the lid. In addition, in some embodiments, the method may include sliding the tamper relative to the scraper when tamping the contents within the interior of the container with the tamper when the scraper is in the stowed position.

These and other advantages and features, which characterize the embodiments, are set forth in the claims annexed hereto and form a further part hereof. However, for a better understanding of the embodiments, and of the advantages and objectives attained through its use, reference should be made to the Figures and to the accompanying descriptive matter, in which there is described example embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of one embodiment of a scraping and tamping device in a second configuration with a tamper disengaged from a scraper for tamping contents within an embodiment of a blender, and illustrating an embodiment of the scraper in a stowed position within a container lid;

FIG. 2 is a bottom perspective view of the scraping and tamping device of FIG. 1 in the second configuration and illustrating the tamper sliding relative to the scraper in the stowed position;

FIG. 3 is an exploded view of the scraping and tamping device away from the container lid of FIG. 1;

FIG. 4 is a perspective view of the scraping and tamping device in a first configuration with the tamper engaged with the scraper for tamping and/or scraping contents within the blender, and illustrating the scraper in a deployed position from the container lid;

FIG. 5 is a bottom perspective view of the scraping and tamping device of FIG. 4 in the second configuration illustrating the tamper moved/slid/disengaged relative to the scraper in the stowed position, and illustrating an elevation and/or second orientation of the tamper which may subsequently engage the scraper upon rotation of the tamper to the first configuration/orientation;

FIG. 6 is a bottom perspective view of the scraping and tamping device of FIG. 5 in the first configuration illustrating the tamper engaged with the scraper in the stowed position upon rotation/movement to the first orientation from the second configuration/orientation;

FIG. 7 is a bottom perspective view of the scraping and tamping device of FIG. 6 in the first configuration illustrating the tamper engaged with the scraper in a deployed position from the lid, and illustrating rotational/vertical movement of the device in the rotational/vertical direction to overcome a retention device;

FIG. 8 is a bottom perspective view of the scraping and tamping device of FIG. 7 in the first configuration illustrating tamping and/or scraping;

FIG. 9 is a bottom perspective view of the scraping and tamping device in the first configuration illustrating the scraper in the deployed position in solid lines and the scraper in the stowed position in broken lines, and illustrating vertical movement of the device in the vertical direction to overcome and/or engage another retention device embodiment.

### DETAILED DESCRIPTION

Numerous variations and modifications will be apparent to one of ordinary skill in the art, as will become apparent from the description below. Therefore, the invention is not limited to the specific implementations discussed herein.

The embodiments of the scraping and tamping device 20 discussed hereinafter will focus on the implementation of the hereinafter-described techniques and apparatuses within a device and/or appliance such as a blender appliance 10, or in other similar applications. However, it will be appreciated that the herein-described techniques and apparatuses may also be used in connection with other types of appliances/devices having mixing volumes/compartments/spaces in some embodiments. In the one embodiment shown in the Figures, the scraping and tamping device 20, or portions thereof, may include one or more tampers 30 and/or one or more scrapers 40. In some embodiments, the device 20 may include one or more blenders 10, or portions thereof. In the one embodiment shown, the blender 10, if used, may include a base 11 with a drive mechanism 12 (e.g. motor), and a blender container 13 with an operable blade or mixing assembly 14 (e.g. one or more blades) therein. The container 13 may include an interior 13a defined by one or more surfaces (e.g. lid, container, or portions thereof). The mixing assembly 14 is engageable to the drive mechanism 12. The container 13 may be removably attached to the base 11. The container 13, if used, may include a lid 15 removably attached to cover the container 13. The lid 15 may define an opening 16 therethrough to access the interior 13a of the container/lid volume. If and when the tamper 30 is not engaging or uninstalled with the lid 15, the blender or lid 15 may include a cover (not shown) to removably engage the opening 16 of the lid 15 between a closed position and an open position. Control over blender 10 by a user is generally managed through a control panel or controls 17 typically disposed on a top or front of base 11, and it will be appreciated that in different blender designs, the control panel 17 may include various types of input and/or output devices, including various knobs, buttons, lights, switches, textual and/or graphical displays, touch screens, etc. through which a user may select/configure one or more settings and start/stop one or more blending cycles of the blender.

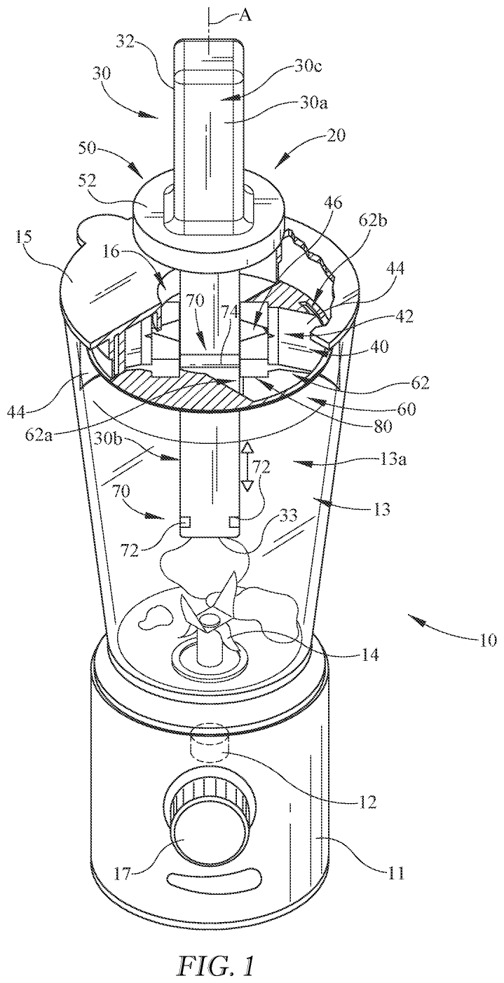

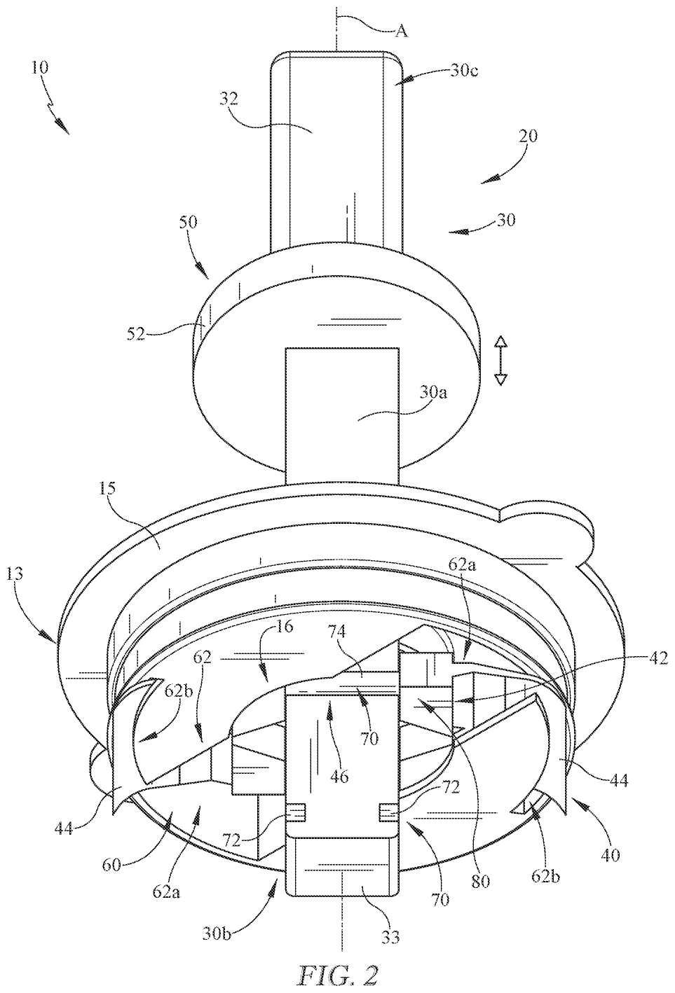

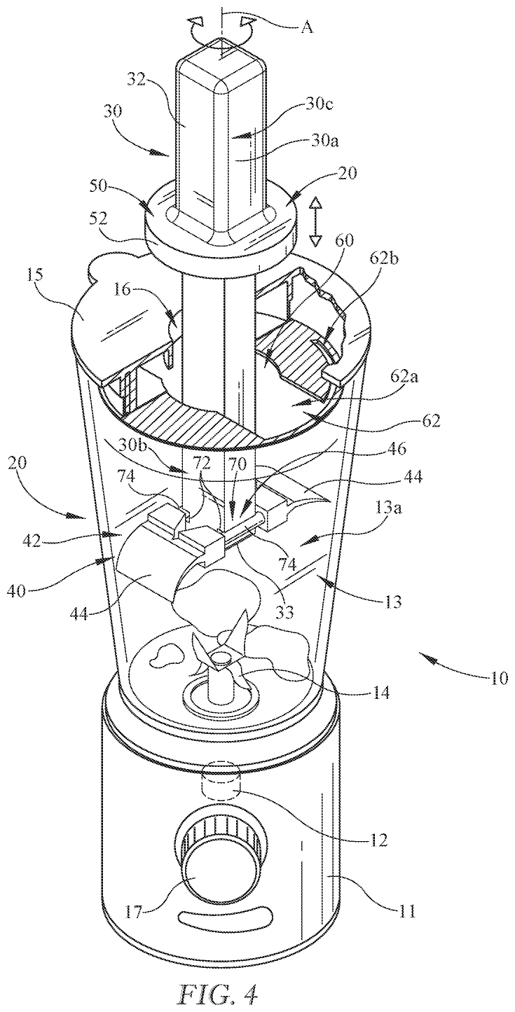

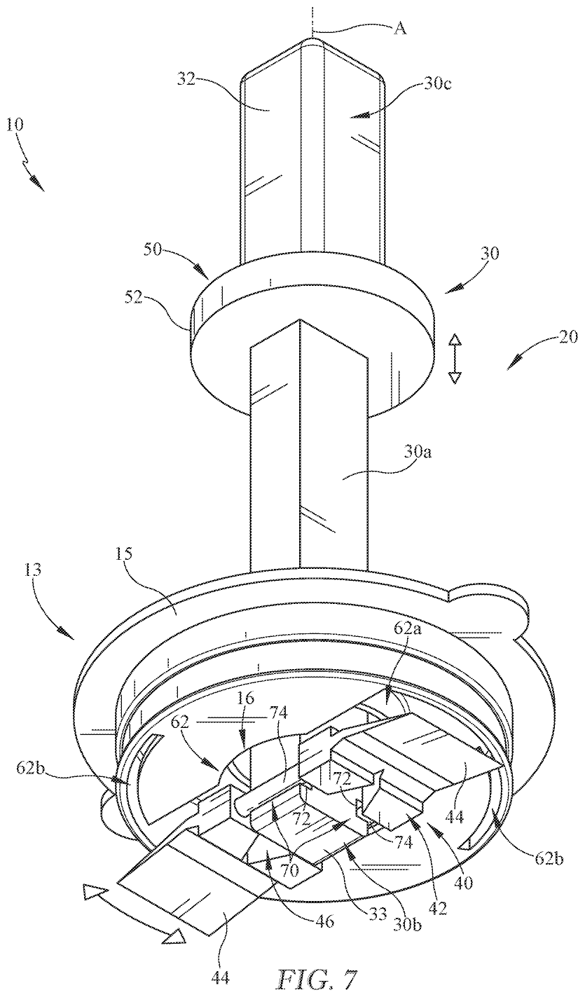

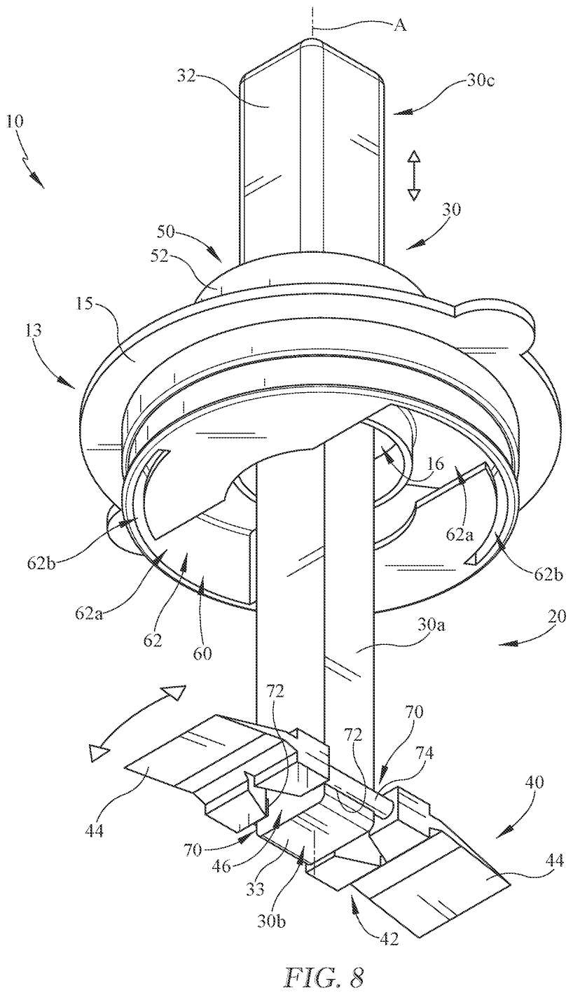

In some implementations, the appliance 10 and/or scraping and tamping device 20 may be used for tamping and/or scraping one or more portions of the appliance (e.g. blender, interior, container, etc.). The tamping and/or scraping may be used during/after/before blending the content(s). As shown in FIGS. 1, 2, 3, and 5, the tamper 30 may be manually moved, used, or forced by the user within the container 13 (e.g. interior 13a) in some applications for tamping content(s). In other applications as shown in FIGS. 4, 7, and 8, the tamper 30 and scraper 40, together or combined, may be manually moved, used, or forced by the user within the container 13 (e.g. interior 13a) for tamping and/or scraping content(s). The user may selectively use the tamper 30 and/or scraper 40 during one or more applications.

In some implementations, the scraping and tamping device 20, or portions thereof, (e.g. tamper, scraper, etc.) is positionable between at least one first or engaged configuration and at least one second or disengaged configuration. In the first configuration, the tamper 30, or portions thereof, (e.g. distal end 30b) may be engaged (e.g. fixedly) with the scraper 40 (e.g. stowed and/or deployed), or portions thereof, (e.g. body 42). In the first configuration as shown in FIGS. 4 and 6-9, the tamper 30 and/or user may manipulate the combined scraper 40 and tamper 30 between positions or within the container 13. In the first configuration, the tamper 30 may carry, drive, and/or be combined with the scraper 40 between positions (e.g. different elevations, angles, vertical positions, rotational positions, etc.) within the container 13 (e.g. interior 13a) for scraping and/or tamping the contents. In the second configuration, the tamper 30, or portions thereof, (e.g. distal end 30b) may be disengaged with the scraper 40, or portions thereof, (e.g. body 42). In the second configuration as shown in FIGS. 1-3 and 5, the tamper 30 and/or user may manipulate the tamper 30 (e.g. separate from the scraper 40, stowed scraper) between positions (e.g. different elevations, angles, vertical positions, rotational positions, etc.) within the container 13. In the second configuration, the tamper 30 may be disengaged or slide from the scraper 40 (e.g. within the container, interior) for tamping the contents. Moreover in the second configuration, the tamper 30 may be separated from or be separate from the scraper 40 (e.g. stowed). As shown in the one embodiment, the tamper 30, or portions thereof, may be positioned within the container 13 and/or extending through the opening 16 of the lid 15 when in the first configuration and/or the second configuration to releasably engage the scraper 40, or portions thereof. Moreover, when in the first configuration and/or second configuration, the scraper 40 may be positioned within the container 13. Alternatively, the scraping and tamping device 20, or portions thereof, may be positioned outside the container when in the first configuration and/or the second configuration.

In some implementations, the scraping and tamping device 20, or portions thereof may include the tamper 30. The tamper 30 may include a body 30a. The tamper 30 and/or body 30a may have a distal end 30b and a proximal end 30c. The tamper 30 or distal end 30b may be inserted or extend through the opening 16 of the lid 15 and at least partially into the interior 13a of the container 13. The tamper 30 or proximal end 30c may extend out from the lid 15 or container 13 and/or may be at least partially exterior to the container/lid. In some embodiments, the proximal end 30c may not project from or be substantially exterior to the container/lid. For example, one tamper embodiment may not include a handle and may be connected/mounted/held to the lid (e.g. flange, etc.) during tamping/scraping. The body 30a or tamper 30 may include the motion limiter 50. The motion limiter 50, if used, may be one or more flanges 52. The tamper 30 or proximal end 30c may include a handle 32 and/or the flange 52. The flange 52, if used, may limit axial insertion of the tamper 30/scraper 40 when engaging the lid 15 of the container 13 and/or when tamping/scraping. The flange 52 may project outwardly (e.g. radially) from the tamper 30, body 30a, proximal end 30c, and/or distal end 30b. In the one embodiment shown, the flange 52 extends outwardly from the proximal end 30c. The handle 32 may extend upwardly or away from the flange 52. The distal end 30b may extend downwardly or away from the flange 52. The tamper 30 or distal end 30b may include a terminal end or surface 33. The distal end 30b may be positioned within the container 13. The tamper or distal end 30b may include a rectangular outer periphery and/or cross-section, although other shapes are within the scope of the invention. The terminal end 33 may be planar as shown in the embodiments. Although a variety of materials made be used, the body 30a or portions thereof may be of a plastic material (e.g. polyurethane) or silicone rubber. The tamper and/or body, or portions thereof, may be a variety of shapes, sizes, quantities, and constructions and still be within the scope of the invention. For example, the body 30a may be made as a single component or multiple components.

In some implementations, the scraping and tamping device 20 and/or scraper 40 may include one or more wiping/scraping blades or structure 44. The one or more wiping blades 44 are used to wipe or scrap contents from the container 13 (e.g. walls, interior 13a) to be blended or towards the mixing assembly 14. The scraper 40 and/or device 20 may include a body 42. The one or more wiping blades 44 may project from the body 42 of the scraper 40. As shown in the one embodiment, two opposing wiping blades 44 may project in opposing directions away from the body and/or tamper. In some embodiments, a single wiping blade may be used. The wiping blade 44 may be made of a flexible material (e.g. silicone, rubber, etc.) to contour and/or flex when applied to the one or more surfaces of the container/interior to wipe or scrap the contents in one or more directions. It should be understood that the scraper, body, and/or blades may be a variety of constructions, quantities, shapes, and sizes and still be within the scope of the invention.

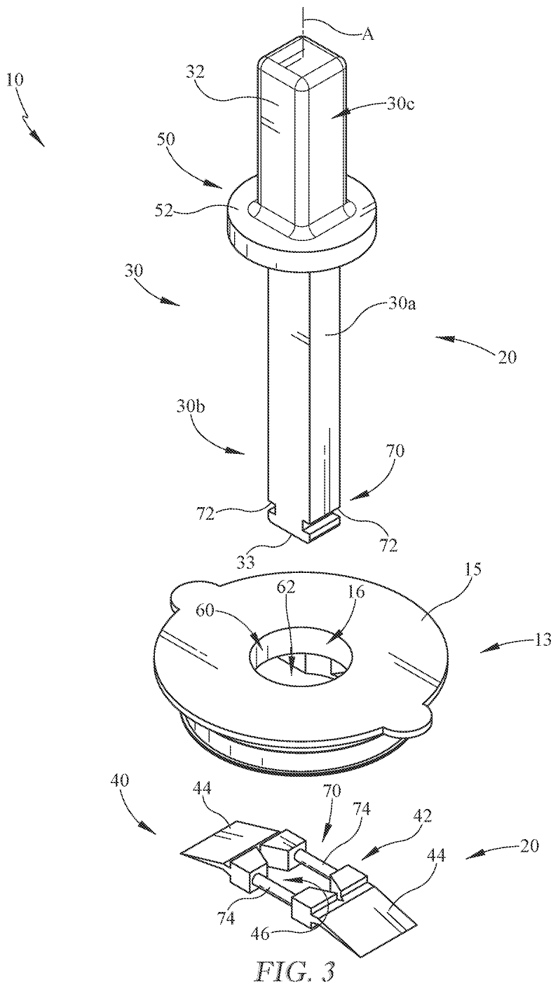

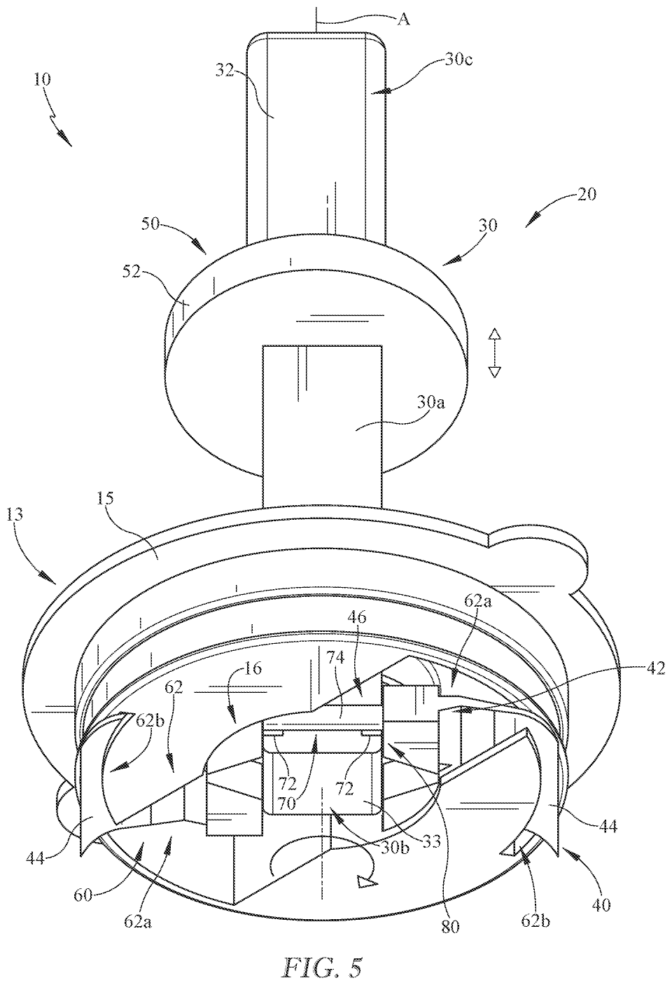

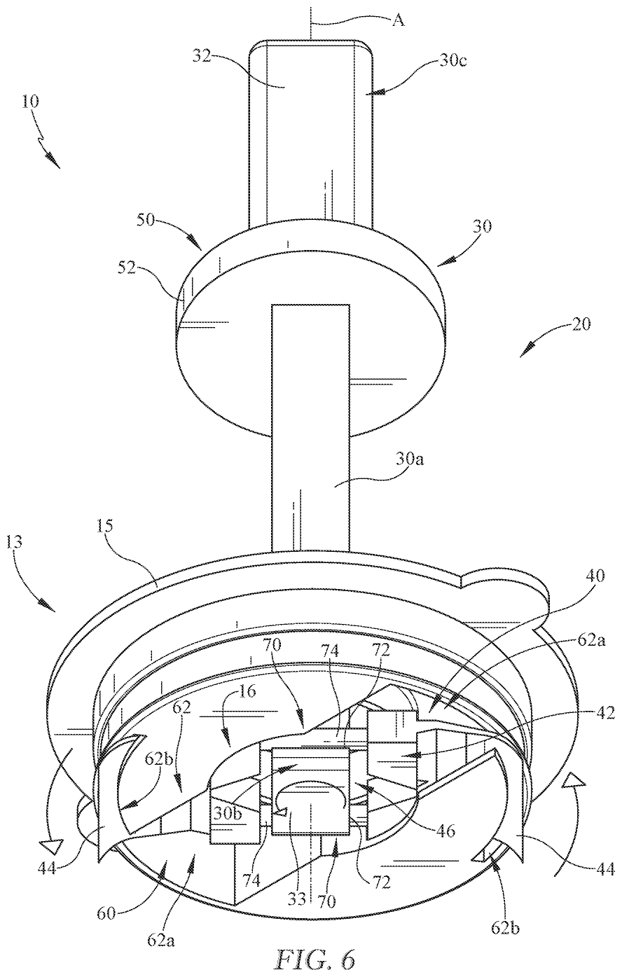

In some implementations, the scaping and tamping device 20, or portions thereof, may include the scraper 40 positionable between a stowed position and a deployed position. The scraper 40 may be stowed in the container 13, or portions thereof. As shown in the one embodiment, the scraper 40 may be stowed in the lid 15 or stowed position and deployed to the deployed position (e.g. away from the lid 15) different from the stowed position. In the one embodiment shown in FIGS. 1, 2, 5, 6, the scraper 40 may be stowed in the stowed position (e.g. lid or portions thereof). In the one embodiment shown in FIGS. 3, 4, and 7-9, the scraper 40 may be deployed to the deployed position, different from the stowed position. The deployed position may be a position away from the lid 15 in some embodiments. As shown in the one embodiment in FIGS. 5 and 6, the device 20 and/or tamper 30 may be positioned between the second configuration (FIG. 5) and the first configuration (FIG. 6) with the scraper 40 when the scraper is in the stowed position (e.g. with the lid). Although it is shown that the tamper may engage or disengage from the scraper when the scraper is stowed (e.g. lid and/or container, blender, or portions thereof), the tamper may releasably engage the scraper in one or more deployed positions in some embodiments.

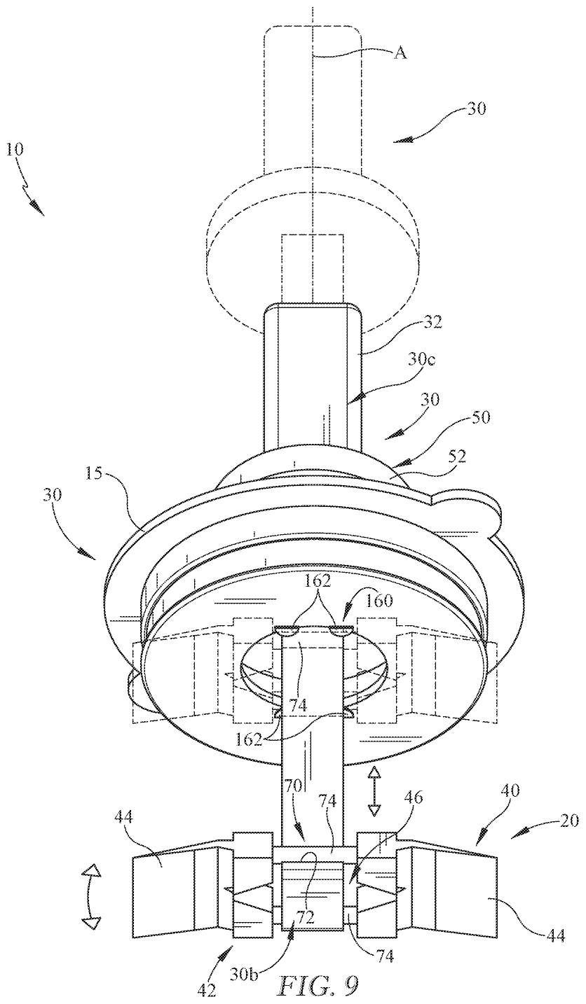

In some implementations, the scraping and tamping device 20 and/or appliance 10, or portions thereof, may include one or more retention devices 60, 160. The one or more retention devices 60, 160 may releasably engage the scraper 40 between the stowed position and the deployed position. The retention device 60, 160 may releasably engage the scraper 40 relative to the lid 15/container 13 between the stowed position and the deployed position. The retention device 60, 160, or portions thereof, may be included in the lid 15 and/or scraper 40. As shown in the one embodiment in FIGS. 1-8, the retention device 60 may include one or more slots/cavities 62 in the lid 15 to releasably receive the scraper 40, or portions thereof. The one or more slots 62 may be a vertical slot 62a engaging or intersecting a circumferential slot 62b within the lid 15, container 13, and/or defining the opening 16, or portion thereof. With the tamper 30 and scraper 40 combined in the first configuration, the deployed scraper 40, or portions thereof, may be axially (e.g. upwardly, vertically) received with the vertical slot(s) 62a of the opening/lid and subsequently rotated (e.g. in one or more rotational directions) into the circumferential slot(s) 62b of the opening/lid to engage/stow/secure the scraper with the container/lid/opening (e.g. stowed position, from the deployed position to the stowed position). The reverse movement (e.g. from the deployed position to the stowed position) between the combined tamper 30 and scraper 40 (e.g. first configuration) and blender 10 (e.g. lid) may disengage the scraper 40 from the slot(s) 62 or lid 15. It should be understood that the retention device may be a variety of constructions, quantities, shapes, and sizes and still be within the scope of the invention. For example, the retention device 160 may only need vertical movement in some embodiments to engage and/or disengage the scraper from the lid. In the one embodiment shown in FIG. 9, the lid 15 (e.g. bottom) may use one or more retention nubs/protrusions 162 to engage/stow the scraper, or portions thereof. The protrusions 162 may releasably engage the scraper body 42 or rods 74, or portions thereof. The tamper 30 and scraper 40 combined may push the scraper 40 out of or past the protrusions 162 to deploy the scraper from the lid 15. When stowing the scraper 40, the protrusions may engage the scraper, or portions thereof. In various embodiments, both the scraper and the lid may have portions of the retention device releasably engaging each other.

In some implementations, the scraping and tamping device 20, or portions thereof, may include one or more releasable engagements 70. The one or more releasable engagements 70 may releasably engage and disengage the tamper 30 and scraper 40 between the first configuration and the second configuration. The releasable engagement 70 may be between the scraper 40, or portions thereof, and the tamper 30, or portions thereof. One embodiment of the releasable engagement 70 is shown in the Figures, the tamper 30 or distal end 30b may include two opposing and parallel grooves 72 (e.g. arcuate, horizontal) in the outer periphery releasable engaging two opposing rods 74 of the scraper 40. The grooves 72 may be on the shorter sides of a rectangular shaped distal end 30b. The scraper 40 or body 42 may include a through opening 46 receiving the distal end 30b of the tamper 30. The through opening 46 may be rectangular in shape in some embodiments. The through opening 46 may be defined by the two opposing rods 74 on the longer side of or defining the through opening 46. To engage the tamper 30 with the scraper 40 from the second configuration to the first configuration, the distal end 30b may be inserted through the through opening 46 of the scraper (e.g. the rectangular shapes or cross-sections are aligned) as shown in FIGS. 1, 2, and 5. Once the grooves 72 and the rods 74 are at the same elevation (e.g. transverse to each other) as shown in FIG. 5, the user may be able to rotate (e.g. in one or more rotational directions) the tamper 30 about the longitudinal axis A extending between the proximal end 30c and distal end 30b of the tamper 30 (e.g. between multiple rotational positions) to engage the tamper with the scraper. Upon rotation, the previously disengaged grooves 72 of the tamper 30 engage the opposing rods 74 (e.g. align, parallel to each other) to position the device in the second configuration as shown in FIG. 6. The rotation of the tamper 30 may be in the counter clockwise direction or towards the distal end of the circumferential slot 62b (e.g. away from the vertical slot 62a) in some embodiments. When in the first configuration as shown in FIG. 6, the user may then push down and turn in the opposing rotational direction (e.g. clockwise) to deploy the combined scraper 40 and tamper 30 from the lid 15, retention device 60, and/or slots 62. Returning the combined tamper 30 and scraper 40 (e.g. when in the first configuration) to the stowed position or end of the circumferential slot 62b, the user may rotate the tamper relative to the scraper to disengage the grooves 72 from the rods 74 to allow the tamper to move/slide (e.g. vertically) relative to the scraper 40. The tamper 30 may be in a first orientation or rotational position relative to the scraper 40 when in the first configuration as shown in FIG. 6 and a second orientation or rotational position relative to the scraper 40 when in the second configuration as shown in FIG. 5. It should be understood that the releasable engagement, or portions thereof, may be a variety of constructions, quantities, shapes, and sizes and still be within the scope of the invention. For example, in some embodiments, the tamper may have the rods/members and the scraper may have the receiving grooves.

In some implementations, the scraping and tamping device 20, or portions thereof, may include one or more sliding engagements 80. The sliding engagement 80, or portions thereof, if used, may be between the scraper 40 and the tamper 30 in at least the second or disengaged configuration. As shown in FIGS. 1, 2, 3, and 5, the tamper 30, or portions thereof, may slide relative to the scraper 40 (e.g. fixed and/or stowed), or portions thereof, for one or more distances and/or directions towards and/or away from the lid/scraper. In some embodiments as shown in FIG. 4, the tamper 30 may slide/move relative to the scraper 40/lid 15 to allow for tamping of the contents when in the second configuration/orientation and/or when the scraper 40 is in the stowed position. Moreover, in various embodiments, the tamper 30 may slide/move relative to the scraper 40/lid 15 to allow the tamper to engage/disengage the releasable engagement 70, or portions thereof, with the scraper. The sliding engagement 80, if used, may allow the tamper to slide out of and/or into the container/lid/scraper (e.g. vertically downward and/or upward). In the one embodiment shown, the tamper may slide in the second orientation when the cross section of the tamper (e.g. rectangular shaped) matches or coincides with the cross section of the through opening of the scraper (e.g. rectangular shaped) to pass therethrough. The sliding engagement may include the through opening 46 slidably engaging the outer periphery of the body 30a. It should be understood that the sliding engagement may be a variety of constructions, quantities, shapes, and sizes and still be within the scope of the invention.

In use, the tamper 30 may be installed or inserted into the blender 10 (e.g. opening, lid, container, interior), or portions thereof. A cover, if used, may be removed from the lid/opening to allow insertion of at least a portion of the tamper 30. With the tamper 30 and/or distal end 30b within the blender volume/interior 13a, the motion limiter 50, if used, may stop further axial insertion. In some embodiments or applications, the scraping and tamping device 20, or portions thereof, may be used to tamp the contents. When in the second configuration, the tamper may move within the interior 13a of the container 13 to tamp the contents (e.g. with the tamper separated from scraper). A sliding engagement 80, if used, may allow the tamper 30 to move/slide relative to the scraper 40 to tamp contents or engage/disengage the tamper from the scraper. The user may slide or move the tamper 30 relative to the scraper 40 when tamping the contents within the interior 13a of the container 13 (e.g. when the scraper is in the stowed position). The tamping of the contents within the container with the tamper may occur when the scraper is in the stowed position. The tamping, when in the second configuration, may occur with or without the mixing assembly operating. In other embodiments or applications, the scraping and tamping device 20, or portions thereof, may be used to scrap and/or tamp the contents (e.g. within the interior of the container with the combined tamper and the scraper). When in the first configuration, the tamper 30 may move/carry the scraper 40 from a stowed position to the deployed position (e.g. relative to the lid). The user may engage the tamper 30 to the scraper 40 or from the second configuration to the first configuration. The user may change the orientation of the tamper relative to the scraper to engage the tamper with the scraper (e.g. when the scraper is in the stowed position). To engage the scraper, the tamper may be rotated/changed from a second orientation/position to a first orientation/position (e.g. about the longitudinal axis) to operably engage the releasable engagement 70 (e.g. rod(s), groove(s), etc.), or portions thereof. The user may use the tamper 30 to deploy the scraper 40 away from the lid/container (e.g. when in the first configuration). For example, once engaged, a push/pull vertical movement and/or rotational movement may disengage or deploy the scraper 40 from the lid 15, retention device 60, 160, protrusions 162, and/or one or more slots 62 (e.g. circumferential slot then the vertical slot). The releasable engagement 70, if used, may engage the tamper 30 with the scraper 40 between the first configuration and the second configuration. In some embodiments, a rotational movement may engage the tamper. The tamping and/or scraping, when in the first configuration, may occur with or without the mixing assembly operating. The user may scrap the contents with the combined tamper 30 and the scraper 40 when the scraper is in the deployed position. The user may tamp alone or also scrap the contents with the combined tamper and the scraper when the scraper is in the deployed position. The user may use the tamp to return or stow the scraper back into or with the lid/container (e.g. when in the first configuration). For example, a push/pull vertical movement and/or rotational movement of the combined tamper and scraper may engage or stow the scraper 40 into the lid 15, retention device 60, 160, protrusion 162, and/or one or more slots 62 (e.g. vertical slot then circumferential slot). The user may disengage the tamper from the scraper or from the first configuration to the second configuration. Once the scrapper is in the stowed position, a rotational movement of the tamper (e.g. in one or more rotational directions) may release the scraper. To disengage the scraper 40 from the tamper 30, the tamper may be rotated from the first orientation to the second orientation (e.g. about the longitudinal axis) to operably disengage the releasable engagement 70 (e.g. rod(s), groove(s), etc.). The user may change the orientation of the tamper relative to the scraper to disengage the tamper from the scraper (e.g. when the scraper is in the stowed position). To disengage the scraper 40, the tamper 30 may be rotated from the first orientation/position to the second orientation/position (e.g. about the longitudinal axis) to operably disengage the releasable engagement 70 (e.g. rod(s), groove(s), etc.), or portions thereof. Once again, the tamper without the scraper (e.g. when stowed, fixed) may be used for tamping the contents or removed from the container/lid.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A scraping and tamping device comprising:
a tamper having a proximal end and a distal end;
a scraper having a body, wherein the body includes at least one wiping blade;
wherein the tamper is positionable between a first configuration and a second configuration with the body of the scraper; and
wherein when in the first configuration the distal end of the tamper engages the body of the scraper whereby the user manipulates the combined scraper and tamper, and when in the second configuration the distal end of the tamper is disengaged from the body of the scraper whereby the user manipulates the tamper separate from the scraper.

2. The scraping and tamping device of claim 1 in combination with a blender, wherein the blender includes a container removably attached to a base, wherein the container includes a mixing assembly engageable to a drive mechanism of the base, wherein the container includes a lid defining an opening, wherein the lid is removably attached to the container, and wherein the tamper extends through the opening of the lid and the scraper is positioned within the container.

3. The scraping and tamping device of claim 1 wherein the tamper is in a first orientation when in the first configuration and a second orientation in the second configuration, wherein the first orientation is different from the second orientation.

4. The scraping and tamping device of claim 1 further comprising a releasable engagement between the tamper and the scraper.

5. The scraping and tamping device of claim 1 wherein the tamper includes a longitudinal axis extending between the proximal end and the distal end, and wherein the tamper rotates about the longitudinal axis between the first configuration and the second configuration.

6. The scraping and tamping device of claim 1 further comprising a sliding engagement between the tamper and the scraper when in the second configuration.

7. The scraping and tamping device of claim 6 wherein the sliding engagement includes the tamper sliding relative to the scraper in a stowed position.

8. A blender comprising:
a base having a drive mechanism;
a container removably attached to the base, wherein the container includes a mixing assembly engageable to the drive mechanism of the base, and wherein the container includes a lid defining an opening, wherein the lid is removably attached to the container;
a scraper having a body, wherein the body includes at least one wiping blade; and
a tamper extending through the opening of the lid is positionable between a first configuration and a second configuration with the body of the scraper, wherein when in the first configuration the tamper engages the body of the scraper whereby the user manipulates the combined scraper and tamper within the container, and when in the second configuration the tamper is disengaged from the body of the scraper whereby the user manipulates the tamper separate from the scraper within the container.

9. The blender of claim 8 wherein the scraper is positionable between a stowed position with the lid and a deployed position different from the stowed position.

10. The blender of claim 9 wherein the tamper is positioned between the second configuration and the first configuration when the scraper is in the stowed position with the lid.

11. The blender of claim 9 further comprising a retention device to releasably engage the scraper relative to the lid between the stowed position and the deployed position.

12. The blender of claim 9 further comprising a sliding engagement between the tamper and the scraper when in the second configuration, wherein the tamper slides relative to the scraper when in the stowed position.

13. The blender of claim 8 wherein the tamper is in a first orientation when in the first configuration and a second orientation in the second configuration, wherein the first orientation is different from the second orientation.

14. The blender of claim 8 further comprising a releasable engagement between the tamper and the scraper.

15. The blender of claim 8 wherein the tamper includes a proximal end and a distal end, and a longitudinal axis extending between the proximal end and the distal end, wherein the tamper rotates about the longitudinal axis between the first configuration and the second configuration relative to the scraper.

16. A method of scraping and/or tamping the contents of a blender container comprising the steps of:
providing a blender having a base and a container removably attached to the base, wherein the base includes a drive mechanism, wherein the container includes a mixing assembly engageable to the drive mechanism of the base, wherein the container includes a lid defining an opening, and wherein the lid is removably attached to the container;
providing a tamper having a proximal end and a distal end;
inserting the tamper through the opening of the lid into an interior of the container;
providing a scraper postionable with the container between a stowed position and a deployed position;
scraping the contents within the interior of the container with the tamper and the scraper when the scraper is in the deployed position; and
tamping the contents within the interior of the container with the tamper when the scraper is in the stowed position.

17. The method of claim 16 further comprising the step of tamping the contents within the interior of the container with the tamper and the scraper when the scraper is in the deployed position.

18. The method of claim 16 further comprising the step of both engaging and disengaging the tamper with the scraper when in the stowed position.

19. The method of claim 18 further comprising the step of changing an orientation of the tamper relative to the scraper when both engaging and disengaging the tamper with the scraper when in the stowed position.

20. The method of claim 16 further comprising the step of deploying the scraper from the lid.

21. The method of claim 16 further comprising the step of stowing the scraper with the lid.

22. The method of claim 16 further comprising the step of sliding the tamper relative to the scraper when tamping the contents within the interior of the container with the tamper when the scraper is in the stowed position.
